(19) United States
(12) Patent Application Publication
(10) Pub. No.: US 2002/0038252 A1
(43) Pub. Date: Mar. 28, 2002

(54) Device and method for making real-time purchases by means of a data communications network

(76) Inventors: Gabrielle Fellus, Milano (IT); Riccardo Hofmann, Milano (IT)

Correspondence Address: MODIANO & ASSOCIATI, Via Meravigli, 16, Milano, 20123, IT

(21) Appl. No.: 09/957,024

(22) Filed: Sep. 21, 2001

(30) Foreign Application Priority Data
Sep. 26, 2000 (IT) MI2000A002091

(51) Int. Cl. G06F 17/60

(52) U.S. Cl. 705/18

(57) ABSTRACT

A device for making purchases in real time over a data communications network, comprising at least one personal computer by means of which a user who wishes to make purchases connects to a data communications network access service provider, at least one second personal computer located within a point of sale whose online site the user wishes to visit in order to make purchases, the second personal computer being connected to the access service provider, and at least one television camera that can move inside the point of sale and is adapted to transmit, by means of the second personal computer, over the data communications network, images of the point of sale, the at least one television camera being such that it can be guided within the point of sale by the user of the first personal computer.

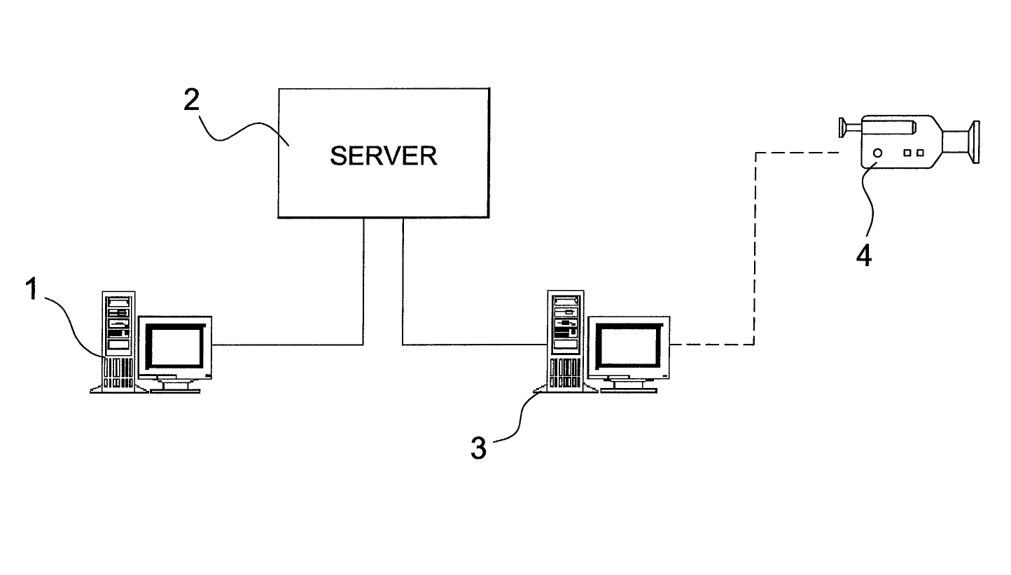

### BACKGROUND OF THE INVENTION

The present invention relates to a device and a method for making real-time purchases by means of a data communications network, particularly the Internet.

It is known that the growing expansion of the Internet has allowed an ever-increasing number of users to enter the so-called “virtual” world simply and substantially inexpensively.

The spread of the possibility to explore the Internet has led a multitude of companies to sell their services or products over this network.

Accordingly, users have available a plurality of sites that provide, for a fee, products and services of various kinds.

The purchase of products and services over the data communications network occurs by viewing the products by means of the screen of one's monitor, browsing through a sort of virtual catalog in which such products are illustrated by means of photographs.

The user can therefore choose, by browsing through the various photographs, the products he is interested in and then complete the purchase for example by using a credit card or a similar payment method.

In this manner, the user has at his disposal a purchasing procedure that allows him to make purchases directly from home, using only his Internet connection.

However, it is evident that the gratification of purchase, usually linked to entering a point of sale and directly viewing the object to be purchased, is highly limited by the fact that it is impossible to make an actual visit to the shop or point of sale whose site the user is visiting.

Actually, what the user is able to see on the screen is merely a catalog of products, among which he can choose the product he is interested in, and with which descriptions of the individual products are usually associated.

In any case, the purchase made in this manner is not particularly attractive for the user, especially in certain fields, such as for example the field of clothing, in which the choice of the user is certainly influenced by the possibility to directly view the item of clothing that he is about to purchase.

Accordingly, the virtual purchase is rather “cold” and deprives the user of the unquestionable pleasure of having a look around the point of sale, stopping to dwell on one or more items he is interested in.

The above-described situation can be extended to points of sale of a different kind, such as for example discotheques, hotels and the like, in which purchasing a ticket for admission to the building or booking a hotel room currently is not possible, except for the booking of hotel rooms, which in some cases can be made by viewing a typical room with pictures that are substantially still images.

### SUMMARY OF THE INVENTION

The aim of the present invention is to provide a device and a method for purchasing goods and services in real time over a data communications network that allows the user to select chosen products or services with direct viewing thereof.

Within this aim, an object of the present invention is to provide a device and a method for purchasing goods and services in real time over a data communications network that allows the user to make a purchase in a manner that is substantially similar to what would occur if the user made the purchase in an ordinary point of sale.

Another object of the present invention is to provide a device and a method for purchasing goods and services in real time over a data communications network, in which the user can make the purchase by employing the presence of assigned personnel directly at the point of sale whose site he is viewing.

Another object of the present invention is to provide a device and a method for purchasing goods and services in real time over a data communications network, which are highly reliable, relatively simple to provide, and at competitive costs.

This aim and these and other objects that will become better apparent hereinafter are achieved by a device for purchasing goods and services in real time over a data communications network, characterized in that it comprises at least one personal computer by means of which the user who wishes to make purchases connects to a data communications network access service provider, at least one second personal computer located within a point of sale whose online site the user wishes to visit in order to make purchases, said second personal computer being connected to said access service provider, and at least one television camera that can move inside said point of sale and is adapted to transmit, by means of said second personal computer, over said data communications network, images of said point of sale, said at least one television camera being such that it can be guided within said point of sale by the user of said first personal computer.

### BRIEF DESCRIPTION OF THE DRAWINGS

Further characteristics and advantages of the invention will become better apparent from the description of preferred but not exclusive embodiments of the device and of the method according to the present invention, illustrated only by way of non-limitative example in the accompanying drawings, wherein the only figure is a block diagram of the device according to the present invention.

### DESCRIPTION OF PREFERRED EMBODIMENTS

With reference to the figure, the device according to the present invention comprises a personal computer 1, by virtue of which a user can connect to a data communications network, such as for example the Internet, by accessing an Internet access service provider 2.

The connection to the access provider 2 allows the user to explore the data communications network and thus enter the sites he is interested in.

The device according to the invention provides for a second personal computer 3 located at a point of sale whose site the user is visiting.

The personal computer 3 installed in the point of sale can be connected to at least one television camera 4, which can be moved conveniently within the point of sale in order to perform a continuous and real-time shot of said point of sale, thus offering the user of the personal computer 1 a view of the interior of the point of sale.

Conveniently, the television camera 4 can be worn or otherwise carried by an assigned operator inside the point of sale, and the connection between the user of the personal computer 1 and the operator who carries the television camera 4 occurs as both video and audio, thus allowing the user of the personal computer 1 to talk with the operator who carries the television camera 4 as if he were actually present in the point of sale.

Substantially, the user of the personal computer 1 who intends to make a purchase in the point of sale in which the television camera 4 movable within the point of sale is installed, can also have at his disposal, in addition to a direct view of the point of sale, a person who can talk with him over the Internet and thus guide him in the purchase.

The user of the personal computer 1 can thus behave, when purchasing a product over the Internet, as if he were physically present in the point of sale, since the television camera 4 provides the requested pictures and voice communication with the operator of the television camera 4 allows him to direct the operator to the area of the point of sale where the objects he likes are located and then bring them into view with said television camera.

Once the user of the personal computer 1 has chosen the product he likes, the purchase can be completed by means of a simple and conventional transaction that can be performed for example by means of a credit card.

Conveniently, if a plurality of points of sale in a same street, for example, have subscribed to the possibility to have a mobile television camera installed in their point of sale, the user who connects to the Internet can, at this point, explore the street, entering in each instance the points of sale he is interested in, and then making at this point a purchase or a guided tour of the point of sale.

In order to ensure controlled access to the various points of sale, it is possible to set access passwords for individual clients if they are not already known.

As an alternative, if one wishes to ensure access substantially to anyone, it is possible to provide for a step for registering the user who wishes to access the point of sale, accordingly entering his name, surname, address, e-mail address and credit card number.

At this point, once the user has been recognized, he can be enabled to enter the point of sale and thus perform a guided tour.

In order to identify the user, it is also possible to provide an additional television camera connected to the personal computer 1 of said user.

It is also possible to define a database containing data of the customers who have accessed the site of the point of sale and have made a guided tour within the point of sale. In this manner it is possible to classify customers according to their behavior in the point of sale, i.e., whether they have simply made a visit, made purchases or behaved inappropriately.

The tastes of the user can also be extracted from the database in which the purchases made by the customer are logged, for example, and therefore in each instance, when the customer accesses the site of the point of sale, the television camera operator can already have an idea of the products in which the user may be interested.

Substantially, therefore, the particularity of the invention is that it is possible to make purchases from one's home personal computer so as to directly enter the point of sale, thus eliminating the coldness and aridity of a purely virtual connection as is currently available for sales over a data communications network.

Moreover, it is undeniable that the user, by being able to make a guided tour within the point of sale, can have a greater opportunity to see articles he is interested in than he would have if he were allowed only to browse through the pages of an electronic catalog.

In practice it has been observed that the device and the method according to the present invention fully achieve the intended aim and objects, since they allow the user to make a guided tour in a point of sale he is interested in, thus being able to purchase products and services with the direct interaction of an operator of the point of sale, who has at his disposal a television camera for showing the user in real time the products and services present in the point of sale.

The device and method thus conceived are susceptible of numerous modifications and variations, all of which are within the scope of the inventive concept; all the details may furthermore be replaced with other technically equivalent elements.

The disclosures in Italian Patent Application No. MI2000A002091 from which this application claims priority are incorporated herein by reference.

What is claimed is:

1. A device for making purchases in real time over a data communications network, comprising at least one personal computer by means of which a user who wishes to make purchases connects to a data communications network access service provider, at least one second personal computer located within a point of sale whose online site the user wishes to visit in order to make purchases, said second personal computer being connected to said access service provider, and at least one television camera that can move inside said point of sale and is adapted to transmit, by virtue of said second personal computer, over said data communications network, images of said point of sale, said at least one television camera being such that it can be guided within said point of sale by the user of said first personal computer.

2. The device according to claim 1, wherein said at least one television camera is carried by an operator inside said point of sale, the movement of said television camera being guided by the user of said first personal computer by voice communication with said operator.

3. The device according to claim 1, wherein said second personal computer comprises a database that is adapted to log the names of users requesting access to the online site of said point of sale.

4. The device according to claim 3, wherein the access of said user to said online site of the point of sale is controlled by a password supplied to said user.

5. The device according to claim 1, further comprising an additional television camera installed at said first personal computer and connected thereto.

6. A method for making real-time purchases over a data communications network, comprising the steps of:
connecting to a data communications network access provider;
entering an address of an online site that a client wishes to visit;
accessing said site;
by interacting with an operator who is present in the point of sale to which said site corresponds, covering a guided path within said point of sale, using at least one television camera that can move within said point of sale;
choosing, by talking with said operator, an item that the client wishes to purchase;
completing the purchase.

7. The method according to claim 6, wherein access to said online site of said point of sale is controlled by a password.

8. The method according to claim 6, comprising a step for registering at the site of said point of sale in order to subsequently obtain permission to access said online site.

9. The method according to claim 6, further comprising a step of logging the behavior of the user who accesses said online site in order to create a database that contains the profile of each user.
